(19) United States
(12) Patent Application Publication
(10) Pub. No.: US 2006/0101016 A1
(43) Pub. Date: May 11, 2006

(54) Medical image transfer apparatus, program and recording medium

(75) Inventor: Takahisa Uehara, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Medical & Graphic, Inc.

(21) Appl. No.: 11/266,458

(22) Filed: Nov. 3, 2005

(30) Foreign Application Priority Data
Nov. 9, 2004 (JP) 2004-325216

(51) Int. Cl. G06F 7/00

(52) U.S. Cl. 707/7

(57) ABSTRACT

A medical image transfer apparatus comprises: a receiving member to receive a plurality of medical images including accompanying information; an extracting member to extract the accompanying information included in each of the medical images; and a transferring member to determine a transfer order of the medical images based on the accompanying information extracted by the extracting member, and to transfer the medical images to an output apparatus in the determined transfer order sequentially.

### BACKGROUD OF THE INVENTION

1. Field of the Invention

The present invention relates to a medical image transfer apparatus and the like which receives a plurality of medical images involving accompanying information and transfers the received medical images to an output apparatus.

2. Description of Related Art

In earlier development, a medical image transfer apparatus has been known, which transfers an medical image photographed or generated by a medical image generating apparatus (hereinafter also referred to as “modality”) such as CT (computed tomography), CR (computed radiography), MRI (magnetic resonance imaging), mammographic apparatus and ultrasonographic apparatus to an medical image forming apparatus such as a film output apparatus.

This medical image transfer apparatus converts medical image data formed by a modality to data of such as DICOM (digital imaging and communications in medicine) standard, and thereafter transfers the data to a medical image forming apparatus. The medical image forming apparatus forms a medical image based on the transferred medical image data on a film, so as to form a hard copy of the medical image.

A camera operator photographs a medical image according to doctor's request or order. The camera operator checks the photographed medical image on a display of a modality, and judges whether the medical image is recorded on a film or not. FIG. 10A is one of the examples of a medical image photographed by a modality (for example, a CT). As shown in FIG. 10A, medical image FG comprises accompanying information FG-2 as well as a subject image FG-1.

The accompanying information comprises a patient ID, name, image number numbered in a photographed order, series number which represents photographed region and photographing method, photographed time, and the like.

The medical images selected by the camera operator are output in the formats as shown in FIG. 10B. The medical images selected by the camera operator are arranged on a film FL shown in FIG. 10B in a predetermined order of such as image frames FG1, FG2, FG3, FG4, . . . .

As described above, the medical images are output after the user (camera operator) arranges the medical images into the frames in an order designated by the user (camera operator). On the other hand, the following art is also known regarding an output order of medical images. The art is such that requests of photographing with various examination methods are accepted, the designated order of photographing in the request is changed, photographing is performed, and photographed results are thereafter output in a desired order (for example, order of requests) (see JP 2000-166908A, hereinafter referred to as patent document 1).

However, the art disclosed in patent document 1 is directed to a plurality of medical images photographed with various examination methods, and is not directed to a plurality of medical images photographed with one predetermined examination method.

That is, when a thoracic part is selected as a region to be photographed, a modality such as a CT and MRI sequentially performs body section radiography with a predetermined examination method at the designated region in a manner such as cephalic side to abdominal side. Thus, a series of section images are photographed with a predetermined examination method in a designated region.

In the light of sequentially photographed medical images, when the arranged order of image frames of the medical images output as shown in FIG. 10B is not an order according to a photographed order or photographed region, a doctor may make a bad diagnosis. Therefore, it has been required that the camera operator carefully designates medical images in view of a photographed order and photographed region.

On the other hand, since the photographed and formed medical images comprise the accompanying information such as image number photographed time, series number and the like as described above, the camera operator can designate the medical images in a desired order by referring this information. However, it has taken a lot of trouble to designate medical images one by one by referring accompanying information.

### SUMMARY OF THE INVENTION

The present invention has been made in the light of the above-described problems. An object of the present invention is to provide a medical image transfer apparatus which transfers a plurality of medical images to a medical image output apparatus in an appropriate order based on the accompanying information thereof.

According to the first aspect of the invention, a medical image transfer apparatus comprises: a receiving member to receive a plurality of medical images including accompanying information; an extracting member to extract the accompanying information included in each of the medical images; and a transferring member to determine a transfer order of the medical images based on the accompanying information extracted by the extracting member, and to transfer the medical images to an output apparatus in the determined transfer order sequentially.

According to the invention, it becomes possible to transfer the medical images to an output apparatus in a proper order based on the accompanying information, regardless of the received order of the medical images. For example, when the medical image transfer apparatus receives the medical images from the modality which sends the medical images in an order designated by a user, the user can designate the medical images regardless of the designation order, without referring the accompanying information of the medical images.

The extracting member preferably comprises a character recognition member to recognize a character included in the accompanying information, and the transferring member comprises an image transferring member to determine the transfer order based on the character recognized by the character recognition member, and to transfer the medical images to the output apparatus in the determined transfer order.

By doing so, it becomes possible to transfer a plurality of the medical images in a proper order based on the character of the accompanying information.

Preferably, the medical image transfer apparatus further comprises a judging member to judge an ejection type of the output apparatus, wherein the transferring member comprises a transfer order determining member to determine whether to reverse the determined transfer order, or not.

By doing so, it becomes possible to determine whether to reverse the transfer order of the medical images or not, based on the ejection type of the output apparatus.

According to the second aspect of the invention, a medical image transfer apparatus comprises: a receiving member to receive a plurality of medical images including accompanying information; an extracting member to extract the accompanying information included in each of the medical images; and a transferring member to determine a position of the medical images based on the accompanying information extracted by the extracting member, and to arrange the medical images to the determined position of each page, and to transfer the page to an output apparatus sequentially.

According to the invention, it becomes possible to transfer the pages to which medical images are arranged to an output apparatus in a proper order based on the accompanying information, regardless of the received order of the medical images. For example, when the medical image transfer apparatus receives the medical images from the modality which sends the medical images in an order designated by a user, the user can designate the medical images regardless of the designation order, without referring the accompanying information of the medical images.

The extracting member preferably comprises a character recognition member to recognize a character in the accompanying information, and the transferring member comprises a page transferring member to determine the position based on the character recognized by the character recognition member, and to transfer the page where the medical images are arranged to the determined position to the output apparatus.

By doing so, it becomes possible to transfer a plurality of the pages to which the medical images are arranged in a proper order based on the character of the accompanying information.

Preferably, the medical image transfer apparatus further comprises a judging member to judge an ejection type of the output apparatus, wherein the transferring member comprises a transfer order determining member to determine whether to reverse the transfer order of the page, or not, based on a judgment result of the judging member.

By doing so, it becomes possible to determine whether to reverse the transfer order of the pages or not, based on the ejection type of the output apparatus.

According to the third aspect of the invention, a computer executable program comprises: a receiving function to receive a plurality of medical images including accompanying information; an extracting function to extract the accompanying information included in each of the medical images; and a transferring function to determine a transfer order of the medical images based on the accompanying information extracted by the extracting function, and to transfer the medical images to an output apparatus in the determined transfer order sequentially.

According to the fourth aspect of the invention, a computer executable program comprises: a receiving function to receive a plurality of medical images including accompanying information; an extracting function to extract the accompanying information included in each of the medical images; and a transferring function to determine a position of the medical images based on the accompanying information extracted by the extracting function, to arrange the medical images to the determined position of each page, and to transfer the arranged page to an output apparatus sequentially.

According to the fifth aspect of the invention, a recording medium which records a computer executable program comprises: a receiving function to receive a plurality of medical images including accompanying information; an extracting function to extract the accompanying information included in each of the medical images received by the receiving function; and a transferring function to determine a transfer order of the medical images based on the accompanying information extracted by the extracting function, and to transfer the medical images to an output apparatus in the determined transfer order.

According to the sixth aspect of the invention, a computer readable recording medium which records a program comprises: a receiving function to receive a plurality of medical images including accompanying information; an extracting function to extract the accompanying information included in each of the medical images received by the receiving function; and a transferring member to determine a position of the medical images based on the accompanying information extracted by the extracting function, and to transfer a page where the medical images are arranged to the determined position to an output apparatus sequentially.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is one example of system constitution of a medical image output system;

FIG. 2A is a view to describe functional constitution of a printer of facedown type;

FIG. 2B is a view to describe functional constitution of a printer of faceup type;

FIG. 3 is block diagram showing one example of functional constitution of a gateway apparatus of an embodiment of the present invention;

FIG. 4 is a view showing one example of data constitution of an ejection type judgment table;

FIG. 5A is a first view showing one example of data constitution of a captured image table;

FIG. 5B is a second view showing one example of data constitution of a captured image table;

FIG. 6 is a view to describe an output image data;

FIG. 7 is a flowchart to describe an image transfer process;

FIG. 8 is a view to describe a format of a frame arrangement of medical images;

FIG. 9 is a view to describe a transfer order of formatted pages to a printer;

FIG. 10A is a view showing one example of a medical image; and

FIG. 10B is a view showing one example of an output format of a film.

### PREFERRED EMBODIMENT OF THE PRESENT INVENTION

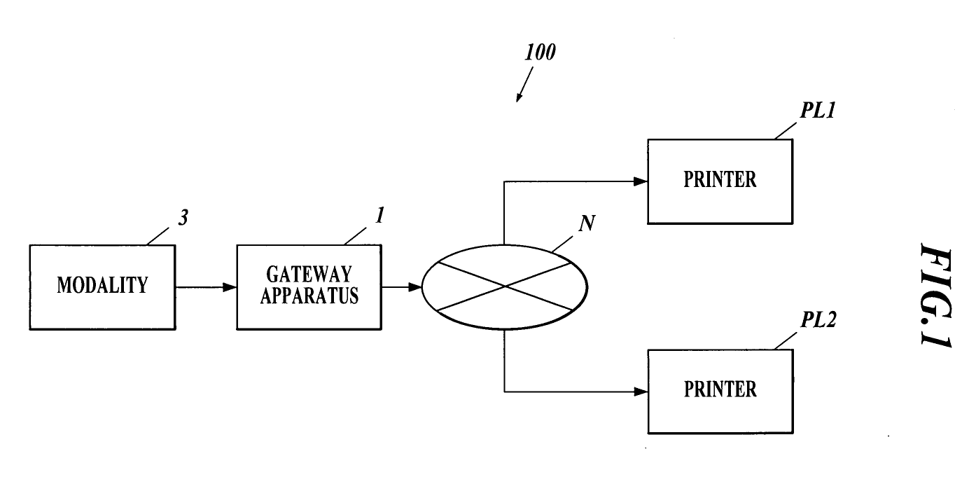

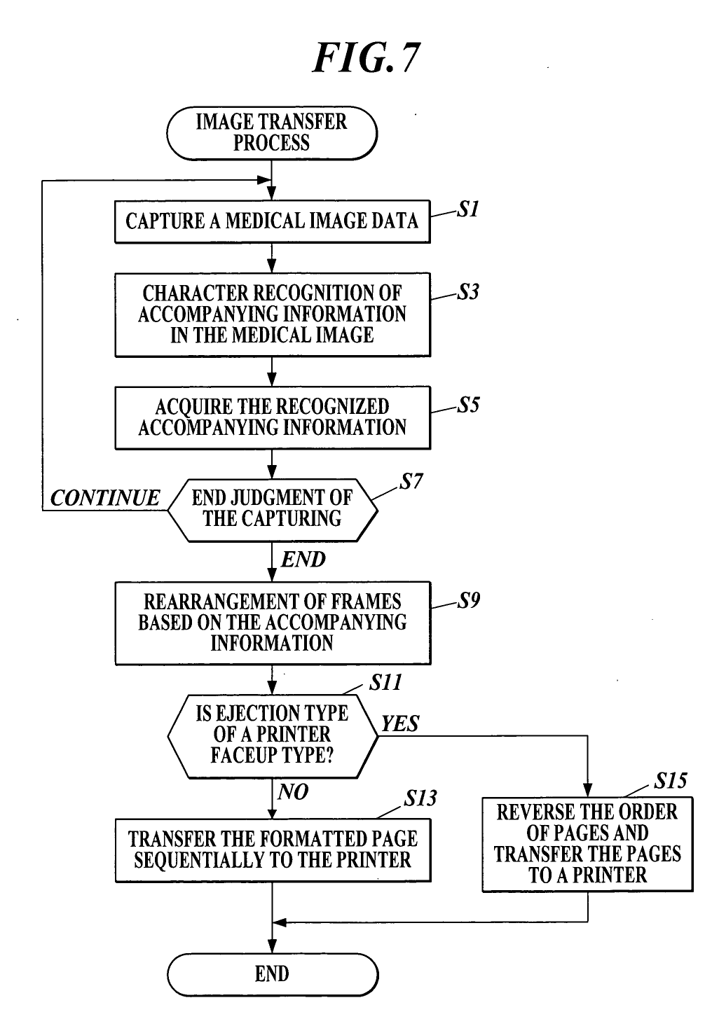

Hereinafter an embodiment of the invention will be described in detail with referring to FIGS. 1 to 9, where the medical image transfer apparatus of the invention is applied to a gateway apparatus.

FIG. 1 is a view showing one example of system constitution of a medical image output system 100. In FIG. 1, the medical image output system 100 has constitution where a gateway apparatus 1 which transfers an medical image output from a modality 3 to one of printers PL1 and PL2 is connected to the printer PL1 and PL2 through a predetermined communication network N.

A user (camera operator) checks a medical image photographed with the modality 3 on a display, and judges whether the image is to be output to a film or not. The designated medical images which the user has judged to output are once stored in the gateway apparatus 1, and a frame format is arranged to each page of a film. When the user checks the frame format of the medical images and confirms the format, the confirmed format is output to one of the printers PL1 and PL2 which has been previously set.

The modality 3 is a medical image generating apparatus to generate data of photographed medical image (analogue or digital video signal, hereinafter referred to as “medical image data”). The modality 3 includes a CT and CR which make a photograph by irradiating X ray, read a X ray image recorded on a photostimulable phosphor sheet so as to form a digital data. Beyond X ray apparatuses, the modality 3 further includes a MRI and ultrasonographic apparatus and the like.

The modality 3 comprises a controller, photographing member, display, input member and I/F member and the like. The controller combines a patient ID, patient name, image number of obtained or formed image, series number and photographed time with an image of a subject photographed by the photographing member, so as to form a medical image, and display the medical image on the display. The controller outputs the medical image which is designated according to user's operation on the input member to the gateway apparatus 1 through the I/F member.

The printers PL1 and PL2 are output apparatuses to form and output the medical image on a film base on the medical image data transferred from the gateway apparatus 1.

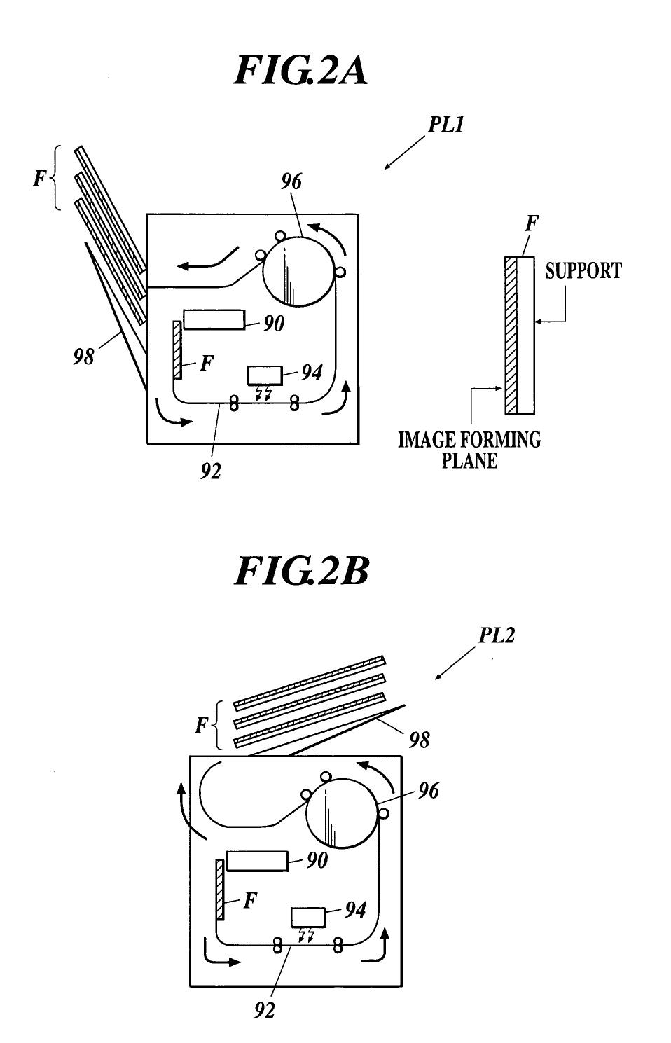

The printer PL1 is a printer of facedown type in which a tray 98 is installed on the side of the main body of the printer as shown in FIG. 2A. The print PL2 is a printer of faceup type in which a tray 98 is installed on the top of the main body of the printer as shown in FIG. 2B. That is, the printers PL1 and PL2 have different position of the tray 98 and different ejection type of a film each other. Identical reference numerals are given to the identical component of the printers PL1 and PL2, and the functional constitutions thereof are described altogether.

The printers PL1 and PL2 respectively comprise a controller, storage, image memory, communicating device and ejection member. Furthermore, they also comprise a film housing member 90, carrying member 92, exposing member 94, developing member 96 and a tray 98 respectively, as shown in FIG. 2. The film F is one in which emulsion containing photosensitive and thermosensitive material is applied on a support of PET (polyethylene terephthalate) or the like so that a photosensitive layer is formed.

The film F is fed from the film housing member 90 to the carrying member 92 according to a control of the controller, and the carrying member 92 carries the film to each member. The exposing member 94 irradiates laser light on the film F to perform exposure, so as to form a latent image of the medical image. The developing member 96 heats the exposed film F so as to visualize (develop) the latent image formed by the exposure. The developed and ejected film F is piled on the tray 98 of each printer.

As shown in FIG. 2A, in the case of the printer PL1, the film F is ejected after it goes round inside the printer, and piled on the tray 98 in a state that a side of photosensitive layer (image forming plane), where the medical image has been made, faces downward. In the case of printer PL2 of FIG. 2B, the film F is ejected after it goes round inside the printer and turns over, and piled on the tray 98 in a state that a side of image forming plane thereof faces upward.

The gateway apparatus 1 captures (reads) the medical image data output from the modality 3 one by one, converts the medical data image according to DICOM standard, stores the data, and transfers the data to the printer which has been previously set.

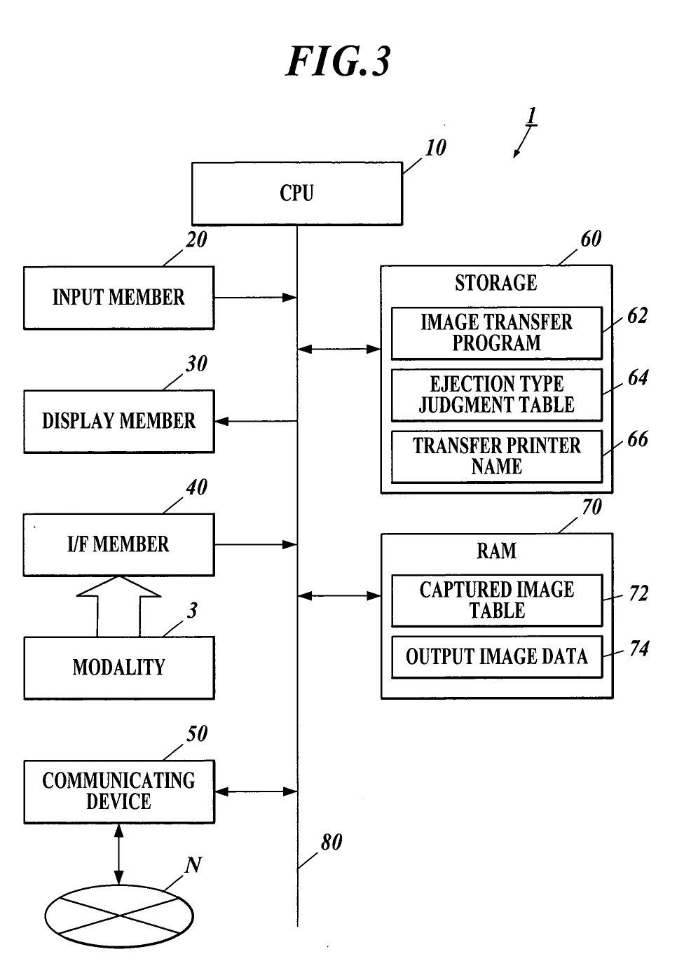

FIG. 3 is a block diagram showing one example of functional constitution of the gateway apparatus 1. In FIG. 3, the gateway apparatus 1 comprises a CPU (central processing unit) 10, input member 20, display 30, I/F member 40, communicating device 50, storage 60 and RAM (random access memory) 70, which are connected to a bus 80.

The CPU 10 reads a program stored in the storage 60 according to an operation signal input from the input member 20, and executes a process according to the program. The CPU 10 outputs display data to display the processing result to the display 30, so as to allow the display to display the processing result.

The input member 20 comprises a pointing device such as a keyboard including a cursor key, numeric keypad and function keys, or a mouse, and outputs a push signal of a pushed key or a position signal of a mouse to the CPU 10.

The display 30 comprises a CRT (cathode-ray tube), LCD (Liquid crystal display) or the like, and displays various screens based on the display data input from the CPU 10.

The I/F member 40 is a functional member to receive and demodulate the medical image data output from the modality 3 and to output the data to the CPU 10. For example, the I/F member 40 includes serial interface such as RS232C, a parallel interface such as Centronics, and USB, and works as a receiving member.

The communicating device 50 is a functional member to connect to a communication network N and to perform a data communication, and comprises a modem, LAN interface and the like. In cooperation with the CPU 10, the communicating device 50 works as a transferring member, transferring function, image transferring member, and page transferring member.

The storage 60 is a functional member to read and write a data or program which performs various functions regarding an operation of the gateway apparatus 1, a data which is processed by the program (not shown), and the like, from and to a recording medium such as a hard disk.

In FIG. 3, the storage 60 stores an image transfer program 62, ejection type judgment table 64 and a transfer printer name 66.

The image transfer program 62 is a program to perform an image transfer process of the present embodiment. The CPU 10 reads out the image transfer program 62 from the storage 60 according to a designation on the input member 20.

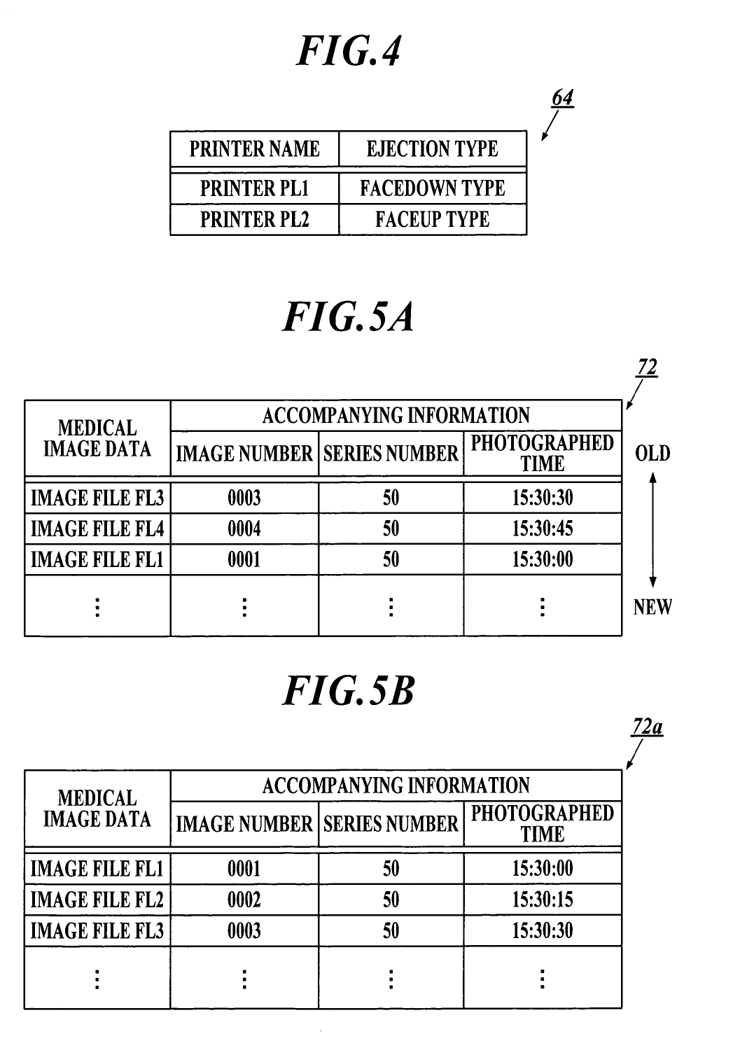

The ejection type judgment table 64 is a data table which stores a printer name and ejection type with the correspondence between them. One example of the data constitution is shown in FIG. 4. The ejection type includes two types of facedown type and faceup type. For example, the printer name “printer PL1” is stored where it corresponds to “facedown type” as the ejection type. This correspondence represents that the printer PL1 is a facedown type printer, i.e. a printer which stores a film or the like in a state that the image forming plane thereof faces downward.

The transfer printer name 66 is a name of a printer to which the output image data 74 where medical image data is formatted page by page is transferred. The transfer printer name 66 is set previously by a user.

The CPU 10 judges ejection type of the printer of the transfer printer name 66, i.e. faceup type or facedown type, with reference to the ejection type judgment table 64. When it is judged that the ejection type is faceup type, the CPU reverses the page order of the output image data 74 and transfers it to the printer of the printer name 66. The CPU 10 works as a judgment member and transfer order setting member.

The RAM 70 is a storage area which temporally stores various programs executed by the CPU 10 and data related to the execution of the programs. In FIG. 3, RAM 70 stores a captured image table 72 and output image data 74.

The captured image table 72 is a data table which cumulatively stores medical image data and accompanying information with the correspondence between them, as shown in FIG. 5A. The accompanying information comprises the image number, series number and photographed time.

The CPU 10 captures the medical image data output from the modality 3 one by one and stores them to the captured image table 72. The CPU 10 performs character recognition such as pattern matching or OCR, so as to recognize a character included in the medical image of the medical image data. The CPU 10 extracts the image number, series number and photographed time of the accompanying information by the character recognition, and stores them to the captured image table 72 with the correspondence thereof to the medical image data. This works as an extract member and character recognition member.

Every time the medical image data is captured, the CPU 10 extracts the accompanying information thereof from the captured data and stores it to the captured image table 72. Any method known in the art can be applied to the method to recognize the character in the medical image data.

Hereupon, it is assumed that the CPU 10 judges that all the medical image data output from the modality 3 are captured, and the CPU 10 forms the captured image table 72 having the data constitution as shown in FIG. 5A. The captured image table 72 of FIG. 5A stores the medical image data in the order output from the modality 3, i.e. in the order designated by the user. This order may be different from the actual photographed order due to incorrect designation of the user.

In the present embodiment, the order of the data in the captured image table 72 is rearranged by the use of the extracted accompanying information. FIG. 5B shows the captured image table 72A in which the order has been rearranged in ascending order of image number. The image number is one which is numbered in each photographing of the medical image. Thus, when the order is rearranged according to the image number, the medical images are rearranged in the photographed order.

As a result, frames of the medical images of the medical image data output from the modality 3 can be arranged to each page, not according to the order designated by the user, but according to the photographed order of the medical image.

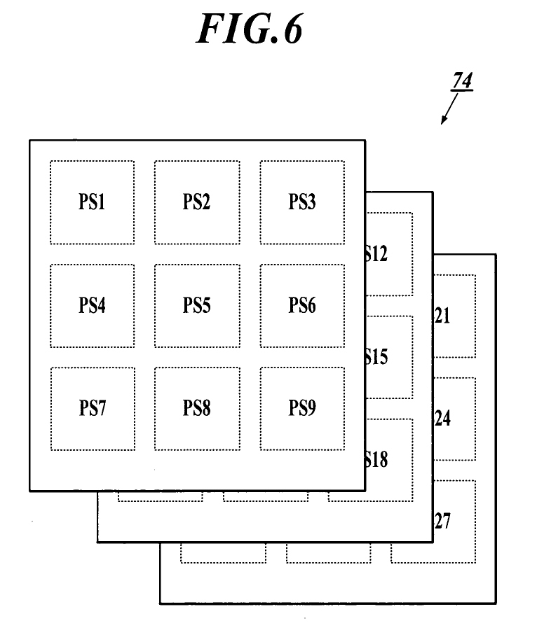

The output image data 74 is an image data in which the medical images formed from the medical image data are arranged to each page. The CPU 10 forms nine frame positions (regions) in each page as shown in FIG. 6, converts the rearranged medical image data stored in the captured image table 72A to DICOM standard, and arranges them to the frame positions in the order such as PS1, PS2, PS3, PS4, . . . . The CPU 10 highlights the frame position where the data has been arranged, and displays a film image as shown in FIG. 6 on the display 30 based on the output image data 74. The number of the frame positions in each page is not limited to nine, and for example, can be changed optionally based on the size of the medical image or user's setting.

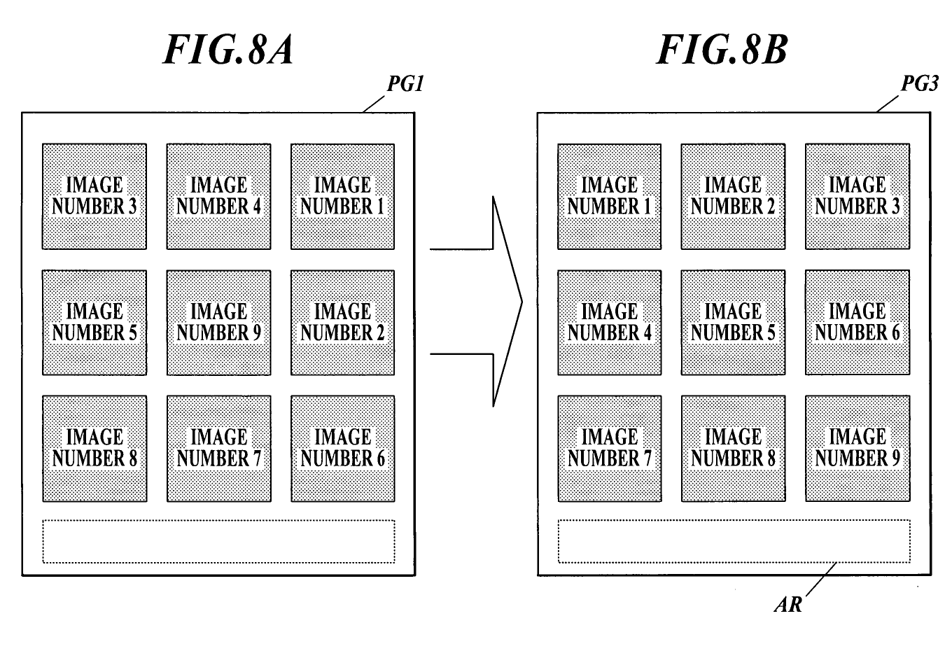

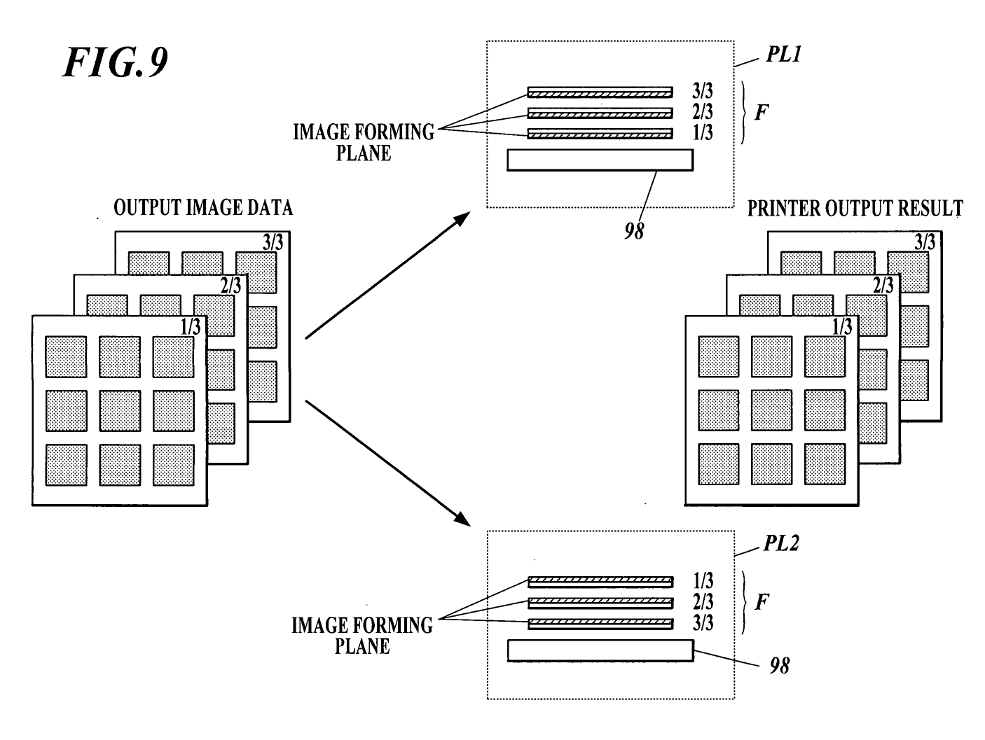

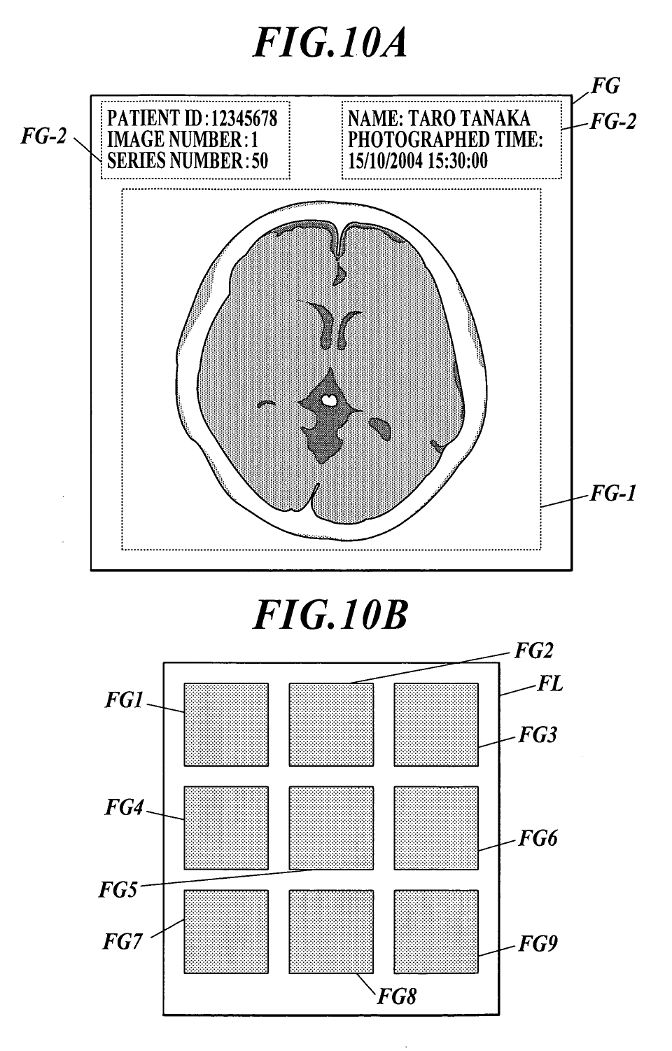

Next, specific operation of the gateway apparatus will be described with reference to FIGS. 8 and 9.

Firstly, when the image transfer process starts, the CPU 10 captures one data of the medical image data output from the modality 3, and stores it to the RAM 72 as the medical image data of the captured image data table 72 (step S1).

Next, CPU 10 performs character recognition of the accompanying information based on the captured medical image data (step S3), and stores the accompanying information obtained and extracted by the character recognition to the captured image table 72 with the correspondence to the medical image data thereof stored in step S1 (step S5).

The CPU 10 judges whether to end the capturing of the medical image data output from the modality 3 or not (end judgment) (step S7). Specifically, the CPU 10 judges that the capturing ends when the CPU 10 detects an end operation (for example, push of an end key) on the input member 20 by the user (step S7: end), and the process shifts to step S9. When the CPU 10 do not detects the end operation, the CPU 10 judges that the capturing continues (step S7: continue). The process shifts to step S1 and the capturing of the medical image data is performed again.

In the embodiment, the end judgment of the capturing of step S7 is performed according to the presence or absence of the end operation of the user. The end judgment can be also performed as follows. The CPU 10 counts time interval until the next medical image data is output from the modality 3. When the time interval reaches a predetermined time period (for example, 10 seconds), it is judged that the capturing ends and the process shifts to step S9.

When the CPU 10 judges in step S7 that the capturing ends (step S7: end), the CPU 10 rearranges the frame formats of each page according to the accompanying information of the captured image table 72. That is, the CPU 10 arranges the captured image table 72 based on the accompanying information as described above, reads out the medical image data of the arranged captured image table 72a sequentially from the first data, and forms the output image data 74 in which the medical image data are sequentially arranged to the frame positions of each page, so that rearrangement of the frame is performed.

For example, when the medical image data are arranged in the order stored in the pre-arranged captured image table 72 as shown in FIG. 5A, the arrangement becomes like page PG1 shown in FIG. 8A. On the other hand, in the present embodiment, the captured image table 72 is rearranged in step S9 to be the data constitution as shown in FIG. 5B. Thus, the arrangement becomes like PG3 shown in FIG. 8B.

That is, the medical images are rearranged in the numeral order of the image number of the accompanying information included in the medical image data. Thus, it becomes possible to prevent the output order of the medical images from being misarranged, even when the user takes a wrong designation order of the medical images in the modality 3.

The method to rearrange the images on the frame is not limited to the method as described in step S9. For example, the medical image data are selected from the captured image table 72 in the numeral order of the image number and the selected medical image data are arranged sequentially to the frame positions of each page, so that the image frames are rearranged.

After step S9, the CPU 10 judges whether the ejection type of the printer which outputs the output image data 74 formed by the rearrangement of the frames is faceup type or not (step S11). Specifically, the CPU 10 selects the ejection type corresponding to the transfer printer name 66 from the ejection type judgment table 64, and judges whether the selected ejection type is faceup type or not.

When the CPU 10 judges that the ejection type is not faceup type, i.e. is facedown type (step S11: No), each page data of the output image data 74 is output to the printer of the transfer printer name 66 in a page order such as 1, 2 and 3 pages (ascending order) (step S13), and the image transfer process ends.

When the CPU 10 judges the ejection type is faceup type (step S11: Yes), each page data of the output image data 74 is output to the printer of the transfer printer name 66 in the inverse page order such as 3, 2, 1 pages (descending order) (step S15), and the image transfer process ends.

For example, it is assumed that the output image data composed of three pages are formed. When the printer to which this output image data 74 are transferred is printer PL1 of facedown type as shown in FIG. 2A, the CPU 10 transfers the output image data 74 of 1, 2 and 3 pages in this order. The films F ejected from the printer PL1 are piled on the tray 98 in which the image forming plane thereof faces downward. Thus, when the piled films are observed from the image forming plane side, the order becomes 1, 2 and 3 pages.

When the printer is printer PL2 of faceup type as shown in FIG. 2B, the CPU 10 reverses the transfer order of the output image data 74 and transfers the data of 3, 2 and 1 pages in this order to the printer PL2. The films F ejected from the printer PL2 are piled on the tray 98 in a state that the image forming plane thereof faces upward. When the piled films are observed from the image forming plane side, the order also becomes 1, 2 and 3 pages. Thus, the order of the piled films can be unified in any printers of both faceup type and facedown type.

According to the present embodiment as described above, a plurality of the medical image data are sequentially transferred to the printer after the order of the medical image data are rearranged based on the accompanying information obtained by the character recognition of each medical image data output from the modality 3. Thus, the order of the medical image on the film ejected from the printer becomes an order based on the accompanying information included in the medical image, regardless of the order of the medical image designated by the user. Therefore, the user can designate the medical image on the modality 3 regardless of the order output from the printer.

When the ejection type of the printer is facedown type, the output image data 74 is transferred to the printer in ascend page order. When the ejection type of the printer is faceup type, the output image data 74 is transferred to the printer in descend page order obtained by reversing the page order of the output image data 74. Thus, the ejected films are piled in an identical page order regardless of type of the printer which is faceup type or facedown type. Therefore, the user need not pay attention to the ejection type of the printer in taking the films, and is only to keep films in a state that the image forming plane faces front. The user need not rearrange the film order.

The present invention is not limited to the above-described embodiment, and can be modified optionally. The followings are possible modifications.

For example, the gateway apparatus 1 and the modality 3 may be integrated, or the modality 3 may have a function as the gateway apparatus 1.

The medical image data are rearranged based on the image number of the accompanying information but also based on the series number or photographed time. For example, when the medical image data are rearranged based on the series number representing a photographed region, the medical images are output on a photographed region to region. The film may be changed with respect to each photographed region, such as a film where cephalic medical images are output and a film where thoracic medical images are output. The medical image data are rearranged in ascend order of the image number in the embodiment. The medical image data may be rearranged in descend order. Further, the order may be changeable according to the diagnosis method or doctor's preference.

The transfer order is reversed when the ejection type of the printer is faceup type in the embodiment. The transfer order may be reversed in the case of facedown type. In this case, the film ejected from the printer arranges in descend page number order (inverse order of the piled order shown in FIG. 9). When a doctor displays the films on a schaukasten from downside, the films are arranged on the schaukasten in the order such as 1, 2 and 3 pages. The transfer order of the page is set not only according to the ejection type of each printer in the embodiment. The transfer order of the page may be set for respective printers.

The medical image data are rearranged based on the accompanying information obtained by the character recognition in the embodiment. The size of the medical image output to the film may be set based on the accompanying information. For example, when the series number of the accompanying information represents that a certain medical image data thereof are a cephalic medical image, the medical image can be output larger than the other medical images.

Further, accompanying information commonly included in each medical image data such as patient ID is obtained by the character recognition of the accompanying information, and such accompanying information may be output to a space area of the film (for example, an area AR in FIG. 8B). The character of the accompanying information included in the medical image arranged on the film is hard to see because it becomes small corresponding to the size of the medical image. When such accompanying information is output separately to the space area, it becomes easily viewable.

The entire disclosure of Japanese Patent Application No. 2004-325216 filed on Nov. 9, 2004, including specification, claims, drawings and summary are incorporated herein by reference in its entirety.

What is claimed is:

1. A medical image transfer apparatus comprising:
a receiving member to receive a plurality of medical images including accompanying information;
an extracting member to extract the accompanying information included in each of the medical images; and
a transferring member to determine a transfer order of the medical images based on the accompanying information extracted by the extracting member, and to transfer the medical images to an output apparatus in the determined transfer order sequentially.

2. The medical image transfer apparatus of claim 1,
wherein the extracting member comprises a character recognition member to recognize a character included in the accompanying information, and
the transferring member comprises an image transferring member to determine the transfer order based on the character recognized by the character recognition member, and to transfer the medical images to the output apparatus in the determined transfer order.

3. The medical image transfer apparatus of claim 1, further comprising a judging member to judge an ejection type of the output apparatus,
wherein the transferring member comprises a transfer order determining member to determine whether to reverse the determined transfer order or not.

4. A medical image transfer apparatus comprising:
a receiving member to receive a plurality of medical images including accompanying information;
an extracting member to extract the accompanying information included in each of the medical images; and
a transferring member to determine a position of the medical images based on the accompanying information extracted by the extracting member, and to arrange the medical images to the determined position of each page, and to transfer the page to an output apparatus sequentially.

5. The medical image transfer apparatus of claim 4,
wherein the extracting member comprises a character recognition member to recognize a character in the accompanying information, and
the transferring member comprises a page transferring member to determine the position based on the character recognized by the character recognition member, and to transfer the page where the medical images are arranged to the determined position to the output apparatus.

6. The medical image transfer apparatus of claim 4, further comprising a judging member to judge an ejection type of the output apparatus,
wherein the transferring member comprises a transfer order determining member to determine whether to reverse the transfer order of the pages or not, based on a judgment result of the judging member.

7. A computer executable program comprising:
a receiving function to receive a plurality of medical images including accompanying information;
an extracting function to extract the accompanying information included in each of the medical images; and
a transferring function to determine a transfer order of the medical images based on the accompanying information extracted by the extracting function, and to transfer the medical images to an output apparatus in the determined transfer order sequentially.

8. A computer executable program comprising:
a receiving function to receive a plurality of medical images including accompanying information;
an extracting function to extract the accompanying information included in each of the medical images; and
a transferring function to determine a position of the medical images based on the accompanying information extracted by the extracting function, to arrange the medical images to the determined position of each page, and to transfer the arranged page to an output apparatus sequentially.

9. A recording medium which records a computer executable program comprising:
a receiving function to receive a plurality of medical images including accompanying information;
an extracting function to extract the accompanying information included in each of the medical images received by the receiving function; and
a transferring function to determine a transfer order of the medical images based on the accompanying information extracted by the extracting function, and to transfer the medical images to an output apparatus in the determined transfer order.

10. A computer readable recording medium which records a program comprising:
a receiving function to receive a plurality of medical images including accompanying information;
an extracting function to extract the accompanying information included in each of the medical images received by the receiving function; and
a transferring member to determine a position of the medical images based on the accompanying information extracted by the extracting function, and to transfer a page where the medical images are arranged to the determined position to an output apparatus sequentially.
